(19) United States
(12) Patent Application Publication
(10) Pub. No.: US 2024/0378421 A1
(43) Pub. Date: Nov. 14, 2024

(54) DEEP LEARNING ARCHITECTURES FOR REDUCING INCIDENTAL TRUNCATION BIAS, AND SYSTEMS AND METHODS OF USE

(71) Applicant: Optum, Inc., Minnetonka, MN (US)

(72) Inventors: Rama Krishna SINGH, Greater Noida (IN); Ravi PANDE, Gautam Budh Nagar (IN); Priyank JAIN, Noida (IN); David Lewis FRANKENFIELD; Anupam GUPTA, Gurgaon (IN)

(21) Appl. No.: 18/314,428

(22) Filed: May 9, 2023

(51) Int. Cl. G06N 3/045; G06N 3/0464; G06V 10/82

(52) U.S. Cl. CPC G06N 3/045; G06N 3/0464; G06V 10/82; G06V 2201/03

(57) ABSTRACT

A system for predicting multiple-sequential-event based outcomes may include: a first deep neural network configured to predict a first decision, and that includes: a first input layer configured to receive as input less than an entirety of a plurality of variables; and an internal layer configured to receive as input a remainder of the plurality of variables appended to an output of a preceding layer, such that the first deep neural network is configured generate a prediction value for the first decision; and a second deep neural network configured to predict a second decision subsequent to the first decision, and that includes: a second input layer configured to receive as input a representation of output from a penultimate layer appended to at least a portion of the plurality of variables, wherein the second deep neural network is configured to generate a prediction value for the second decision.

### TECHNICAL FIELD

Various embodiments of this disclosure relate generally to deep learning architectures for reducing incidental truncation bias, and, more particularly, to systems and methods using sequential convolutional neural networks for predicting multiple-sequential-event based outcomes.

### BACKGROUND

Models of multiple-sequential-event based outcomes generally are subject to a type of bias known as “incidental truncation.” A famous statistical science example of this bias involved estimating the average wage for women in the late 1970s from samples of wages from working women. The selection of the samples was inherently biased because they were not truly randomly selected; housewives were excluded as samples by self-selection. In other words, women who made a first decision not to enter the workforce were incidentally truncated from being selected as samples for the second decision regarding a wage amount.

In statistical science, there are mathematical techniques that may be used to account for incidental truncation, such as Heckman two-stage modelling using the inverse Mills ratio. However, while conventional techniques, including the foregoing, may be readily applied to modelling structured data using classical statistics techniques and formulae, such conventional technologies may not be adaptable to other types of models, such as models utilizing unstructured data or techniques like artificial intelligence or deep learning.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for using deep learning to predict multiple-sequential-event based outcomes, and/or to deep learning architectures to account for and/or reduce incidental truncation bias.

Predictions for multiple-sequential-event based outcomes made using systems, methods, and/or deep learning architectures incorporating aspects of this disclosure exhibit improved accuracy, e.g., relative to deep learning prediction models that do not account for incidental truncation. Such techniques also enable using a common data set for models of different decisions in a multiple-sequential-event based outcome. Further, such techniques enable tuning models for different scenarios, e.g., by selecting different variables for consideration for different decisions in a multiple-sequential-event based outcome.

In one aspect, a system for predicting multiple-sequential-event based outcomes includes: one or more storage devices storing computer-readable instructions; one or more processors configured to execute the computer-readable instructions to implement: first deep neural network that is configured to predict a first decision for a multiple-sequential-event based outcome, and that includes: a first input layer configured to receive as input less than an entirety of a plurality of variables for the multiple-sequential-event based outcome; and an internal layer configured to receive as input a remainder of the plurality of variables appended to an output of a preceding layer, such that the first deep neural network is configured generate as output a prediction value for the first decision; and a second deep neural network that is configured to predict a second decision subsequent to the first decision for the multiple-sequential-event based outcome, and that includes: a second input layer configured to receive as input a representation of output from a penultimate layer of the first deep neural network appended to a representation of at least a portion of the plurality of variables, wherein the second deep neural network is configured to generate as output a prediction value for the second decision.

In another aspect, a computer-implemented method of predicting a multiple-sequential-event based outcome using deep learning includes: obtaining, by one or more processors, a plurality of variables for the multiple-sequential-event based outcome; identifying, by the one or more processors, less than an entirety of the plurality of variables as first input; injecting, by the one or more processors, a remainder of the plurality of variables as a portion of second input to an internal layer of a first neural network; generating, by the one or more processors, a prediction of a first decision of the multiple-sequential-event based outcome by applying the first input to an input layer of the first neural network, such that a remainder of the second input is fed to the internal layer, the internal layer configured to generate as output a prediction value for the first decision; generating, by the one or more processors, third input by combining the first input with a representation of output from a penultimate layer of the first neural network; and generating, by the one or more processors, a prediction of a second decision of the multiple-sequential-event based outcome by applying the third input to a further input layer of a second neural network configured to generate as output a prediction value for the second decision.

In a further aspect, a computer-implemented method of training a series of deep neural networks for predicting multiple-sequential-event based outcomes includes: obtaining, by one or more processors, a plurality of training sets of variables, each training set including a respective plurality of variables and respective data describing decision outcomes for at least one decision, a first subset of the plurality of training sets of variables including respective data describing only a first decision outcome, and a second subset of the plurality of training sets of variables including respective data describing the first decision outcome and a second decision outcome; training, by the one or more processors and using the plurality of training sets, a first neural network to generate predictions of the first decision; and training, by the one or more processors and using the second subset of the plurality of training sets, a second neural network to generate predictions of the second decision.

It is to be understood that both the foregoing general description and the following detailed description include examples and are explanatory only and are not restrictive of the disclosed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 depicts an example environment for predicting multiple-sequential-event based outcomes and/or accounting for incidental truncation, according to one or more embodiments.

FIG. 2A depicts an example embodiment of a deep learning model for predicting a decision of a multiple-sequential-event based outcome.

FIG. 2B depicts another example embodiment of a deep learning model for predicting a decision of a multiple-sequential-event based outcome.

FIG. 3A depicts a flowchart of an example method of training deep learning models for predicting multiple-sequential-event based outcomes and/or accounting for incidental truncation, according to one or more embodiments.

FIG. 3B depicts a flowchart of an example method of training a first deep learning model for predicting a first decision of a multiple-sequential-event based outcome and/or accounting for incidental truncation, according to one or more embodiments.

FIG. 3C depicts a flowchart of an example method of training a second deep learning model for predicting a second decision of a multiple-sequential-event based outcome and/or accounting for incidental truncation, according to one or more embodiments.

FIG. 4 depicts an example method of using deep learning models for predicting a second decision of a multiple-sequential-event based outcome and/or accounting for incidental truncation, according to one or more embodiments.

FIG. 5 depicts an example of a computing device, according to one or more embodiments.

### DETAILED DESCRIPTION OF EMBODIMENTS

According to certain aspects of the disclosure, methods and systems are disclosed for predicting multiple-sequential-event based outcomes, e.g., predicting a decision on a medical claim denial being upheld resulting from a prior decision to file an appeal. Multiple-sequential-event based outcomes may be subject to bias due to incidental truncation. Generally, models operate under the assumption that samples are randomly selected. However, when a final outcome is dependent on multiple events, this may not be the case. For example, the samples available to train a model for a decision regarding a target variable are truncated due to selection via a prior decision or model. To continue the previous example, samples of medical decisions to uphold denials of medical claims are implicitly selected from samples in which an appeal is filed in the first place. In other words, samples in which an appeal is not filed may have been incidentally truncated when building the model of the decisions to uphold the denial. As a result, the model of the decisions for the success of an appeal may be biased.

When a model is expressed as formulae, as in classical statistical modelling, there are mathematical techniques that may be used to account for incidental truncation, such as the inverse Mills ratio. However, conventional techniques, including the foregoing, may not be adaptable to other types of models, such as models utilizing artificial intelligence or deep learning.

The use of artificial intelligence, and in particular of deep learning, may have many benefits for generating predictions. For example, a deep learning model may be trained to account for variables or links between variables that may be unintuitive or difficult to express via conventional statistics or mathematical models. However, when deep learning models are used to predict a multiple-sequential-event based outcome, traditional mathematical techniques for addressing incidental truncation may not be applicable. To continue with the medical claim appeals example, a deep learning model for predicting a decision to uphold a claim denial would only have available as training data samples for which an appeal was filed in the first place. Further, it may be desirable to predict the result of a decision to uphold an appeal before a medical claim has been formally or officially denied, e.g., to avoid denying claims that are likely to be successfully appealed. However, the input data to predict the final decision to uphold the denial is also from a state prior to the decision of a patient to file an appeal. Thus, the model may be subject to bias due to incidental truncation. Moreover, a deep learning model does not have an explicit formula that can be adjusted by application of the inverse Mills ratio.

Accordingly, improvements in technology relating to deep learning architecture that account for bias due to incidental truncation are needed. As will be discussed in more detail below, in various embodiments, deep learning architectures as well as systems and methods of use are described for predicting multiple-sequential-event based outcomes and/or reducing or accounting for incidental truncation.

Examples in this disclosure are made with reference to medical claim appeals and other multiple-sequential-event based outcomes. However, it should be understood that reference to any particular activity is provided in this disclosure only for convenience and as an example, and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The term “provider” generally encompasses an entity or agent thereof involved in providing goods or services to a person, e.g., healthcare to a patient. The term “medical claim” generally encompasses a request for payment, reimbursement, indemnification, or the like that may be submitted to a provider, e.g., for diagnosis, procedures, and/or services provided to a patient by a provider. The term “medical code” generally encompasses an alphanumeric reference to a diagnosis, service, procedure, or the like, whereby the alphanumeric reference may have a syntax or structure that relates different characters in the alphanumeric reference to various features associated with the provider, the services provided, and/or the person being provided services.

As used herein, a “deep learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A deep learning model is generally trained using training data, e.g., experimental data and/or samples of input data, which are fed into the model in order to establish, tune, or modify one or more aspects of the model, e.g., the weights, biases, criteria for forming classifications or clusters, or the like. Aspects of a deep learning model may operate on an input linearly, in parallel, via a network (e.g., a neural network), or via any suitable configuration.

The execution of the deep learning model may include deployment of one or more deep learning techniques, such as linear regression, logistical regression, random forest, gradient boosted machine (GBM), deep learning, and/or a deep neural network such as a convolutional neural network, a recursive neural network, long-short-term memory deep network, a simple deep learning network, a transformer, etc. Supervised training may be employed. For example, supervised learning may include providing training data and labels corresponding to the training data, e.g., as ground truth. Any suitable type of training may be used, e.g., stochastic, gradient boosted, random seeded, recursive, epoch or batch-based, etc.

As noted above, conventional techniques of addressing incidental truncation bias may not be applicable to models leveraging deep learning. For instance, as noted above, a conventional deep learning model cannot be readily adjusted by an inverse Mills ratio, as would a classical statistical model.

In an example use case, a deep learning architecture adapted to predicting multiple-sequential-event based outcomes is employed. To adapt the medical claim example above to this use case, a medical claim includes various data regarding a patient, a provider, and/or services or procedures provided. Such data includes, for example, one or more medical codes, patient demographic data, billing information, provider information, etc. A first portion of that data, e.g., a subset of the variables that are substantially probative of the likelihood that a claim denial will be appealed but not substantially probative of the likelihood that an appeal of the denial will be successful, is identified relative to a second portion, e.g., the remainder of the variables. The likelihood of a final success of an appeal may depend on the filing of an appeal in the first place. And, while some of the data, e.g., the portion probative of the likelihood of an appeal, may also be applicable to the likelihood of success of the appeal, some of the data, e.g., costs and/or amounts associated with the claim, may have less of an impact. This latter portion, which is generally a smaller portion of the data than the former, may be formed from elements that only impact the filing of an appeal, e.g., the first decision or event. As a result, this latter portion may act as exclusion restrictions. For example, a cost of the medical claim may impact a likelihood that a denial will be appealed, but may have little impact on the ultimate outcome of such an appeal.

The appeal success prediction for the medical claim is modelled as a multiple-sequential-event-based outcome, e.g., with a first deep learning model modelling selection (e.g., whether a denial is likely to result in an appeal of the denial), and second deep learning model modelling the outcome of the appeal. The second portion of the medical claim data is fed into the first model as input, and the first portion of the medical claim data is injected, e.g., as a feed forward, at a downstream stage of the first model. An output from an a penultimate layer of the first model is added to the medical claim data, e.g., the second portion of the data, to form an input for the second model. This architecture may account for incidental truncation, and thus provide results with less bias and/or higher accuracy.

In a particular, example, the first and second models include a Convolutional Neural Network (CNN). The second portion of the data is encoded as and/or used to generate an image acceptable as input into a first CNN trained to predict whether a denial of the claim is likely to be appealed. Additionally, the first portion of the data is injected into one of the deep layers of the first CNN, e.g., an internal layer in advance of a fully connected layer acting as a binary classifier for denial appeal or no appeal. A second CNN is trained to predict whether an appeal will be successful. A tensor output of the penultimate layer of the first deep learning network, which acts as a selection variable, is added to the image representation of the medical claim data, and then input into the second CNN.

While several of the examples above involve multiple-sequential-event based outcomes for medical claim denials and appeals, it should be understood that techniques according to this disclosure are adaptable to any suitable type multiple-sequential-event based outcome. Moreover, the techniques disclosed herein are adaptable to multiple-sequential-event based outcomes with any number of decisions. It should also be understood that the examples above are illustrative only.

Presented below are various aspects of deep learning architectures and techniques that are adapted to predicting multiple-sequential-event based outcomes and/or accounting for incidental truncation bias. As will be discussed in more detail below, deep learning techniques adapted to such activities include one or more aspects according to this disclosure, e.g., a particular architecture, a particular handling or preparation of input data, etc.

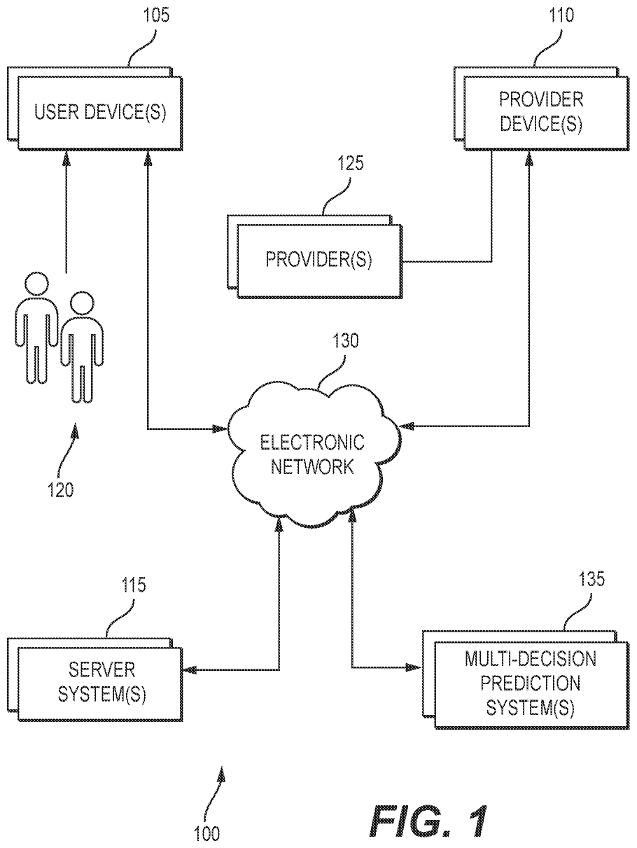

FIG. 1 depicts an example environment 100 that is utilized with techniques presented herein. One or more user device(s) 105, one or more provider device(s) 110, and one or more server system(s) 115 may communicate across an electronic network 130. As will be discussed in further detail below, one or more multi-decision prediction system(s) 135 may communicate with one or more of the other components of the environment 100 across the electronic network 130. The one or more user device(s) 105 is associated with a user 120, e.g., a patient being provided care. The one or more provider device(s) 110 is associated with a provider 125, e.g., a person or entity involved in providing the care to the patient.

In some embodiments, one or more of the components of the environment 100 are associated with a common entity, e.g., an insurance provider, a medical care provider such as a hospital, or the like. In some embodiments, one or more of the components of the environment is associated with a different entity than another. The systems and devices of the environment 100 may communicate in any arrangement. As will be discussed herein, systems and/or devices of the environment 100 may communicate in order to one or more of generate, train, or use a deep learning model to account for incidental truncation in predicting multiple-sequential-event based outcomes, and/or to predict multiple-sequential-event based outcomes such as the outcome of an appeal resulting from a decision of whether to file an appeal, among other activities.

The user device 105 is configured to enable the user 120 to access and/or interact with other systems in the environment 100. For example, the user device 105 is a computer system such as, for example, a desktop computer, a mobile device, a tablet, etc. In some embodiments, the user device 105 includes one or more electronic application(s), e.g., a program, browser, etc., installed on a memory of the user device 105. In some embodiments, the electronic application(s) is associated with or enable the user 120 to interact with one or more of the other components in the environment 100. For example, the electronic application(s) include a browser usable to access an online medical claim interface hosted by the server system 115. The user device, in some embodiments, includes a User Interface (UI) configured to receive and display notifications, e.g., predictions associated with a multiple-sequential-event based outcome. In embodiments, such a notification includes a predicted decision result, a confidence value, or any other data associated with the prediction such as input data used with one or more deep learning models.

The provider device 110 includes, for example, a server system, an electronic medical data system, computer-readable memory such as a hard drive, flash drive, disk, etc. In some embodiments, the provider device 110 includes and/or interacts with an application programming interface for exchanging data to other systems, e.g., one or more of the other components of the environment. The provider device 110 includes and/or act as a repository or source for data such as medical data and/or medical claim data relating to the user 120. Medical data includes, for example, one or more of data associated with a procedure, treatment, or diagnosis, demographics, patient or family health history, patient health status, and/or medical codes associated therewith.

The server system 115 may host, implement, track, and/or facilitate services or procedures relating to a multiple-sequential-event based outcome. For example, the server system 115 may store medical claim data such as, for example, medical data, billing data, approval data, insurance plan data, etc. In another example, the server system 115 is associated with an insurance provider, and may facilitate procedures relating to filing and/or processing medical claims. The server system 115 is configured to interact, e.g., via an API or the like, with the provider device 110 in order to process medical data for a medical claim. For instance, the insurance provider is enabled to communicate regarding costs, approvals, user information, provider information, etc. The server system 115 is configured to interact with the user device 105. For instance the insurance provider may host a website that enables the user 120 to view medical claim information, add or update personal information, interact with a medical claim, e.g., appeal a denial, etc. The server system 115, in some embodiments, is configured to perform other actions relating to facilitating a multiple-sequential-event based outcome. For instance, the server system 115 may facilitate, e.g., automatically and/or based on human instruction, approving or denying medical claims, ruling on an appeal, or the like. As discussed in further detail below, such actions are based at least in part upon predictions. For example, the decision as to whether to deny a claim is based at least in part upon a prediction of how likely the denial is to be appealed and/or how likely such an appeal, if filed, is to be successful.

Various criteria are used to apply such predictions to a decision. For example, in some cases a prediction is binary, e.g., an appeal is predicted to succeed or fail. In some cases, a prediction is a likelihood, e.g., an appeal is predicted to have a 60% chances of succeeding. Any suitable means of accounting for such predictions is used, such as a rubric, heuristic, algorithm, etc. As noted above, making predictions when multiple decisions are at play may have challenges. Thus, the server system 115 is configured to interact with the multi-decision prediction system 135 in order to generate such predictions, as discussed in further detail below.

In various embodiments, the electronic network 130 is a wide area network (“WAN”), a local area network (“LAN”), personal area network (“PAN”), or the like. In some embodiments, electronic network 130 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that includes data configured to cause a program such as a web browser to perform operations such as send, receive, or process data, generate a visual display and/or an interactive interface, or the like.

As discussed in further detail below, the multi-decision prediction system 135 may one or more of generate, store, train, or use deep learning model(s) configured to predict decisions for a multiple-sequential-event based outcome. The multi-decision prediction system 135 includes, for example, a module or algorithm for representing data in a manner acceptable as input to the deep learning model(s), one or more deep learning model(s) and/or instructions associated with the deep learning model, e.g., instructions for generating a deep learning model(s), training the deep learning model(s), using the deep learning model(s), etc. In an example, the multi-decision prediction system 135 includes instructions for retrieving medical claim data, generating input for one or more deep learning model, using the deep learning model(s) to predict one or more decisions of a multiple-sequential-event based outcome, and/or operating the user device 105 to output information related to the predicted decision(s) and/or outcome. In an example, the multi-decision prediction system 135 causes the UI of the user device 105 to output data relating to a prediction of one or more decisions of the multiple-sequential-event based outcome.

In some embodiments, a system or device other than the multi-decision prediction system 135 is used to generate and/or train the deep learning model. In an example, such a system includes instructions for generating the deep learning model, the training data and ground truth, and/or instructions for training the deep learning model. A resulting trained deep learning model may then be provided to the multi-decision prediction system 135.

Generally, a deep learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output is compared with the ground truth to determine an error, which may then be back-propagated through the model to adjust the values of the variable.

Training is conducted in any suitable manner, e.g., in batches, and includes any suitable training methodology, e.g., stochastic or non-stochastic gradient descent, gradient boosting, random forest, etc. In some embodiments, a portion of the training data is withheld during training and/or used to validate the trained deep learning model, e.g., compare the output of the trained model with the ground truth for that portion of the training data to evaluate an accuracy of the trained model. The training of the deep learning model is configured to cause the deep learning model to learn associations between one or more decisions and one or more features in medical claim data, such that the trained deep learning model is configured to predict a decision in response to the input medical claim data based on the learned associations.

In various embodiments, the variables of a deep learning model is interrelated in any suitable arrangement in order to generate the output. For example, in some embodiments, the deep learning model includes image-processing architecture that is configured to identify, isolate, and/or extract features, geometry, and or structure in input represented as an image. For example, medical claim data and/or medical codes associated therewith is represented as an image, whereby the deep learning model(s) includes one or more Convolutional Neural Network (“CNN”) configured to identify features in the input image, and includes further architecture, e.g., a connected layer, neural network, etc., configured to determine a relationship between the identified features in order to predict a decision based on the input medical claim data, as discussed in further detail below.

Although depicted as separate components in FIG. 1, it should be understood that a component or portion of a component in the environment 100 may, in some embodiments, be integrated with or incorporated into one or more other components. For example, a portion of the server system 115 may be integrated into the user device 105 or the like. In another example, the multi-decision prediction system 135 may be integrated into the server system 115. In some embodiments, operations or aspects of one or more of the components discussed above may be distributed amongst one or more other components. Any suitable arrangement and/or integration of the various systems and devices of the environment 100 may be used.

As noted above, in some embodiments, multiple neural networks, e.g., multiple CNNs are used to predict multiple-sequential-event based outcomes, e.g., with a respective network for each decision. In some embodiments, the multiple-sequential-event based outcome models a situation in which occurrence of a second decision depends upon a result of the first decision. For example a first decision may relate to whether a denial of a medical claim is appealed, and a second decision may relate to whether a filed appeal is successful. In each instance, the second decision being reached depends on the first decision having an outcome resulting in the filing of an appeal. In such situations, incidental truncation is at play unless accounted for, e.g., via a deep learning architecture as discussed below.

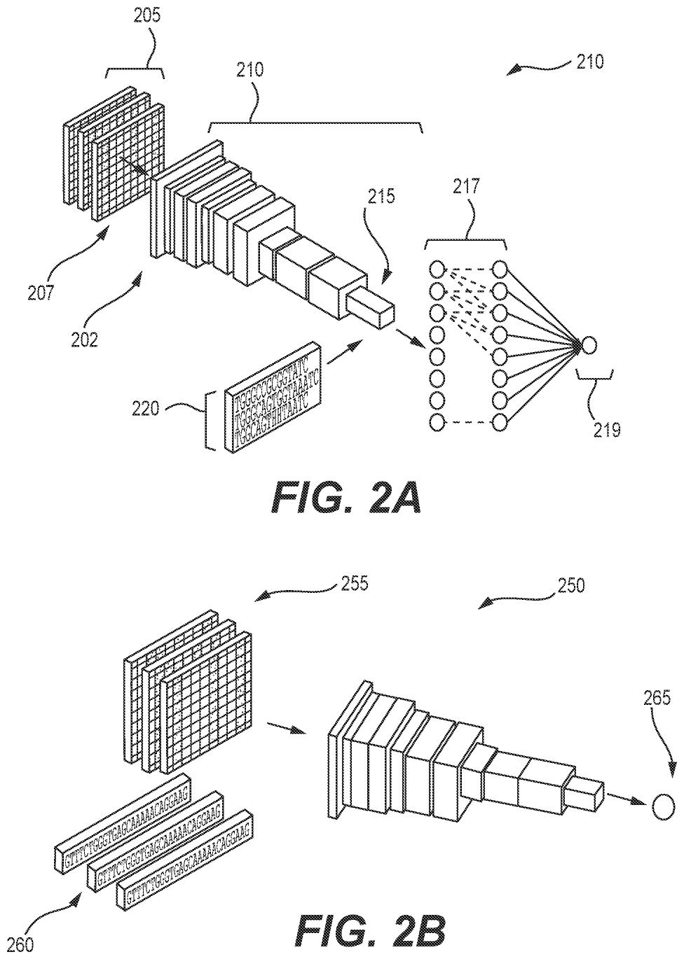

FIG. 2A depicts a schematic of an exemplary embodiment of a first CNN 200 for predicting a first decision in a multiple-sequential-event based outcome, e.g., predicting whether a denied medical claim will be appealed. As illustrated in FIG. 2A, the first CNN 200 is configured to receive input data 205, e.g., medical claim data, represented as an image 207. In this embodiment, the input image 207 is represented as a tensor having three layers, but any suitable number of layers is used.

The first CNN includes a first input layer 202 configured to receive the input data 205. In some embodiments, representing the input data 205 as the input image 207 includes applying an encoder or the like to the input data 205. In some embodiments, the first input layer 202 is configured to receive less than an entirety of the input data 205. For example, the input data 205 includes a plurality of variables, e.g., various features associated with a medical claim, and some of the plurality of variables is withheld from the input data 205.

The first CNN 200 includes one or more hidden layers 210. For each hidden layer, a filter, also referred to as a kernel or the like, e.g., a sub-tensor learned via a training process, is convolved over the input to that layer in order to generate an output indicative of features in the input data corresponding to the filter. In some embodiments, additional layers are dispersed among hidden layers 210, e.g., a RelU layer, a softmax layer, etc.

A penultimate hidden layer 215 (also referred to herein as an internal layer 215) leads into a fully connected layer 217, e.g., a classifier that generates an output 219 indicative of a prediction of the model. In some embodiments, the penultimate layer 215 is configured to receive input not only from a preceding hidden layer 210, but also from an injection of further input data 220. For example, a remainder of the plurality of variables, e.g., variables withheld from the input data 205, is injected as input into an internal layer such as the penultimate layer 215, such that the remainder is appended to the output of the preceding hidden layer 210. The remainder of the plurality of variables may act as exclusion restrictions e.g., so as to inhibit multi-collinearity in the first and second deep learning networks. In some embodiments, the withholding and injections as discussed above is beneficial with regard to accounting for incidental truncation. In some embodiments, the remainder of the plurality of variables that is withheld from the input data 205 and that is injected into the penultimate layer 215 includes one or more variables that are substantially probative of the first decision and that are not substantially probative of the second decision.

FIG. 2B depicts a schematic of an exemplary embodiment of a second CNN 250 for predicting a second decision in a multiple-sequential-event based outcome, e.g., predicting whether an appeal of a denied medical claim will be successful. As illustrated in FIG. 2B, the input data 255 is appended with a tensor representation 260 of output from the penultimate layer 215 from the first CNN 200, e.g., to act as a selection variable or function. In some embodiments, e.g., in which the input data is a multi-level image, the tensor representation 260 of the output is applied to each layer. In some embodiments, this combination may act as a pseudo selection function for the second deep learning network.

In some embodiments, the input data for the second CNN 250 is the same as the input data 205 of the first CNN 200. The second CNN 250 is configured to generate an output 265, e.g., via a classifier, indicative of a prediction of the second decision in the multiple-sequential-event based outcome. In some embodiments, the first CNN 200 and the second CNN 250 were trained based on a common dataset of pluralities of variables, e.g., a common pool of medical claim data and decision outcomes.

Further aspects of the deep learning model(s) and/or how they are utilized to predict multiple-sequential-event based outcomes and/or account for incidental truncation are discussed in further detail in the methods below. In the following methods, various acts are described as performed or executed by a component from FIG. 1, such as the multi-decision prediction system 135, the user device 105, or components thereof, such as a deep learning model like the first and second CNNs 200 and 250 depicted in FIGS. 2A and 2B. However, it should be understood that in various embodiments, various components discussed above may execute instructions or perform acts including the acts discussed below. An act performed by a device is considered to be performed by a processor, actuator, or the like associated with that device. Further, it should be understood that in various embodiments, various steps may be added, omitted, and/or rearranged in any suitable manner.

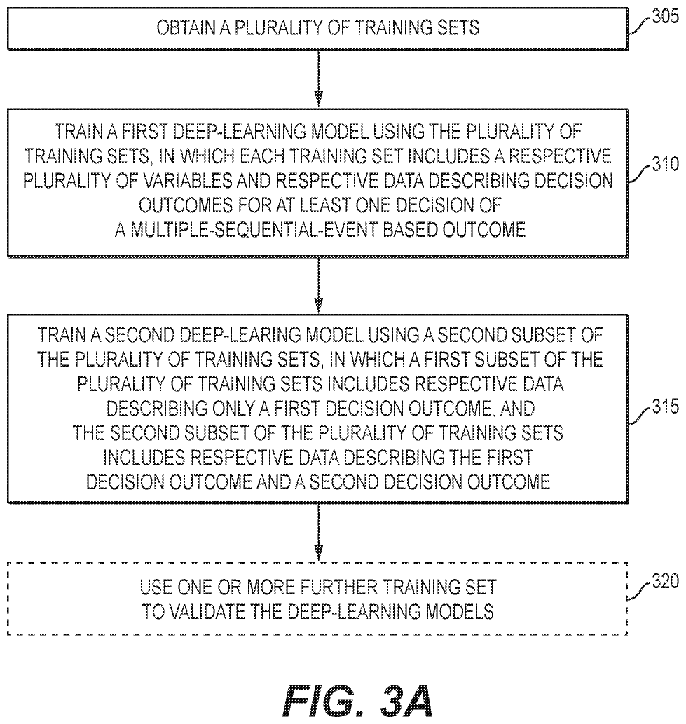

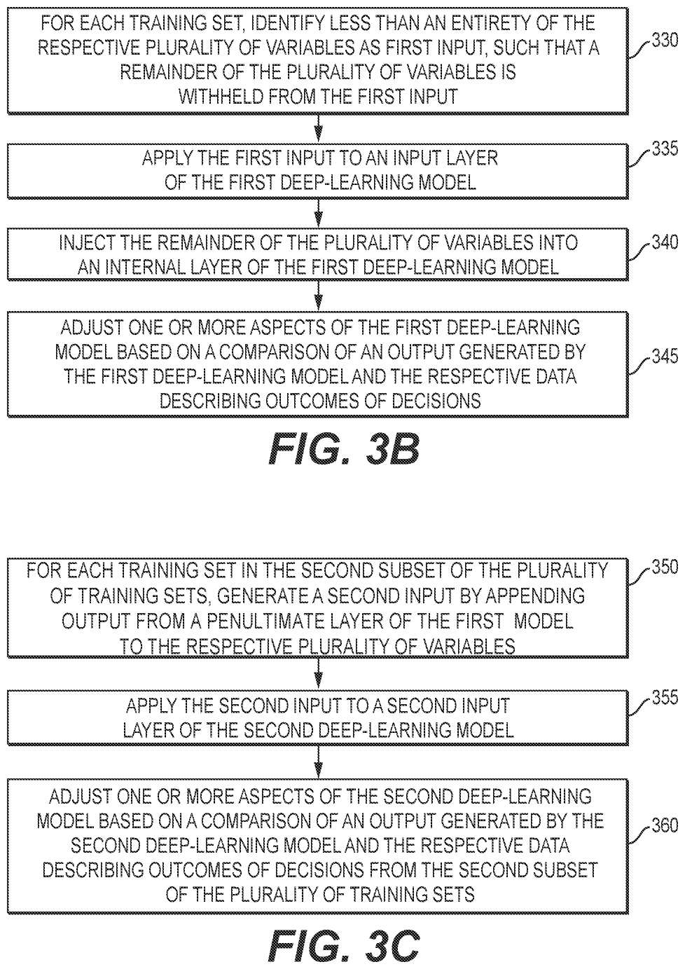

FIG. 3A illustrates an example process for training deep learning models for predicting a multiple-sequential-event based outcome that includes a first decision and a second decision, such as in the various examples discussed above. At step 305, a plurality of training sets are obtained. Each training set includes a respective plurality of variables and respective describing decision outcomes for at least one decision of the multiple-sequential-event based outcome. The plurality of variables includes, for example, medical data and/or medical code data associated therewith. The data describing a decision outcome includes a measurement or historical data resulting from one or more decision associated with the plurality of variables. For example, the data describing a decision outcome includes an indication that an appeal was filed or was not filed for a respective medical claim associated with medical claim data, and includes an indication if an appeal, if filed, was successful or not.

As noted above, in multiple-sequential-event based outcomes, not all samples may have reached all decisions that are to be modelled. For instance in the examples above, some medical claim denials may not have been appealed, and thus never reached a decision regarding success or failure of an appeal. Thus, a first subset of the plurality of training sets includes respective data describing only a first decision outcome, and a second subset of the plurality of training sets includes respective data describing the first decision outcome and a second decision outcome.

At step 310, a first deep learning model, e.g., a neural network such as CNN 200, is trained using the plurality of training sets, to generate predictions of the first decision. Further aspects of training the first deep learning model are discussed below with regard to FIG. 3B.

At step 315, a second deep learning model, e.g., a neural network such as CNN 250, is trained using the second subset of the plurality of training sets to generate predictions of the second decision.

Optionally, at step 320, one or more further training sets are used to validate the deep learning models. For example, input of a further plurality of variables is used to generate an output from one or more of the deep learning network, which is compared with further decision data in order to evaluate an accuracy of the predictions of the models.

FIG. 3B illustrates an example process for training the first deep learning model (step 310 of FIG. 3A). At step 330, for each training set, less than an entirety of the respective plurality of variables is identified as first input, e.g., such that a remainder of the respective plurality of variables is not identified for the first input. In some embodiments, the remainder of the plurality of variables includes one or more variables that are substantially probative of the first decision and that are not substantially probative of the second decision. For example, a billed amount for a medical claim is substantially probative of whether a denial of that claim is likely to be appealed, by may not be substantially probative of whether that appeal will ultimately succeed or not.

At step 335, the identified first input is applied to a first input layer of the first deep learning model. In some embodiments, applying the first input includes representing the first input as an input image, e.g., that is acceptable as input to a CNN.

At step 340, the remainder of the plurality of variables is injected into an internal layer, e.g., a layer toward the output such as a penultimate layer of the first deep learning model. And, at step 345, one or more aspects of the first deep learning model are adjusted based on a comparison of an output generated by the first deep learning model with the respective data describing decision outcomes of the first decision from the training set. For example, in the case of a CNN, an error between the output and the respective data describing decision outcomes is back-propagated through the CNN to adjust one or more weights of one or more filters for one or more hidden layers of the CNN.

FIG. 3C illustrates an example process for training the second deep learning model (step 315 of FIG. 3A). At step 350, for each training set in the second subset of the plurality of training sets, a second input is generated by appending output from the internal layer of the first deep learning model (e.g., a tensor representation thereof) to the respective plurality of variables, e.g., as a selection variable or function.

At step 355, the second input is applied to a second input layer of the second deep learning model. In some embodiments, applying the second input includes representing the second input as a further input image, e.g., that is acceptable as input to a CNN.

At step 360, one or more aspects of the second deep learning model are adjusted based on a comparison of an output generated by the second deep learning model with the respective data describing decision outcomes of the second decision from the second subset of the plurality of training sets. For example, in the case of a CNN, an error between the output and the respective data describing decision outcomes is back-propagated through the CNN to adjust one or more weights of one or more filters for one or more hidden layers of the CNN.

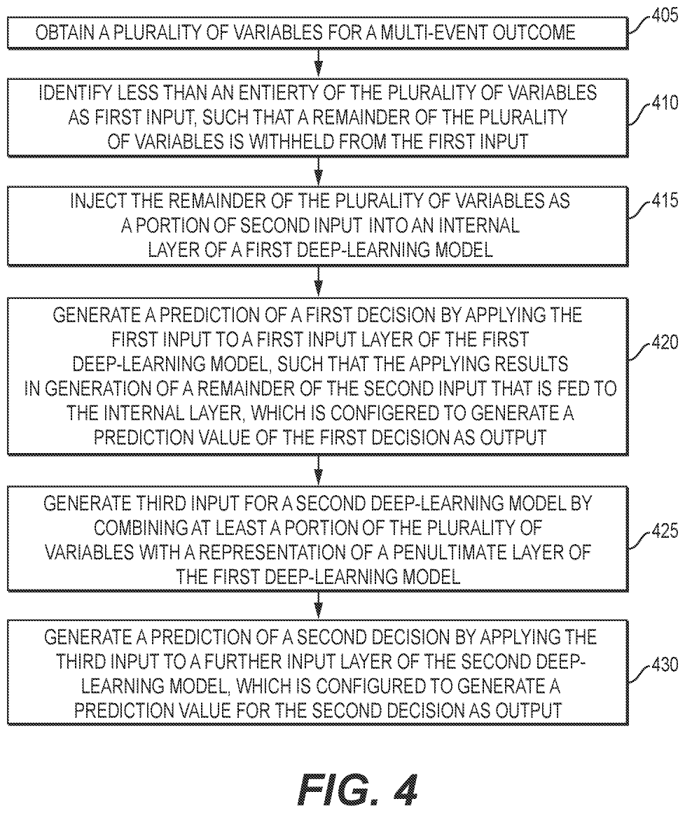

FIG. 4 illustrates an exemplary process for predicting a multiple-sequential-event based outcome that accounts for incidental truncation, e.g., by utilizing trained deep learning models such as deep learning models trained according to one or more embodiments discussed above. In some embodiments, the multiple-sequential-event based outcome models a situation in which occurrence of the second decision depends upon a result of the first decision.

At step 405, a plurality of variables for a multiple-sequential-event based outcome is obtained. For example, medical claim data and/or medical codes associated therewith are obtained for a particular medical claim of a patient.

At step 410, less than an entirety of the plurality of variables is identified as first input, e.g., so that a remainder of the plurality of variables is withheld from the first input. In some embodiments, the remainder of the plurality of variables includes one or more variable that is substantially probative of the first decision and that is not substantially probative of the second decision.

At step 415, the remainder of the plurality of variables is injected as a portion of a second input into an internal layer, e.g., a penultimate layer, of a first neural network, e.g., CNN 200.

At step 420, a prediction of the first decision is generated, by the first neural network, by applying the first input to an input layer of the first neural network. The operation of the first neural network is configured such that the application of the first input results in generation of a remainder of the second input that is fed to the internal layer along with the portion of the second input based on the reminder of the plurality of variables. The penultimate layer is configured to generate as output a prediction value for the first decision.

In some embodiments, applying the first input to the input layer of the first neural network includes representing the first input as a first input image and providing the first input image to the first input layer. In some embodiments, representing the first input as the first input image includes applying an encoder or the like to the first input.

At step 425, third input for a second neural network, e.g., CNN 250, is generated by combining at least a portion the plurality of variables, e.g., the original input to the first neural network, with a representation of output from the penultimate layer, e.g., a tensor, e.g., as a selection variable or function.

At step 430, a prediction of the second decision is generated by applying the third input to a further input layer of the second neural network. The second neural network is configured to generate as output a prediction value for the second decision.

In some embodiments, applying the third input to the input layer of the second neural network includes representing the third input as a second input image and providing the second input image to the further input layer. In some embodiments, representing the third input as the second input image includes generating a partial input image based on the plurality of variables, e.g., the first input. A tensor is generated based on the penultimate layer, and the tensor is appended to each layer of the partial input image.

It should be understood that embodiments in this disclosure are exemplary only, and that other embodiments may include various combinations of features from other embodiments, as well as additional or fewer features. For example, while some of the embodiments above pertain to multiple-sequential-event based outcomes relating to medical claims and denial appeals, any suitable multiple-sequential-event based outcome may be modelled.

In general, any process or operation discussed in this disclosure that is understood to be computer-implementable, such as the processes illustrated in FIGS. 3A-4, is performed by one or more processors of a computer system, such any of the systems or devices in the environment 100 of FIG. 1, as described above. A process or process step performed by one or more processors may also be referred to as an operation. The one or more processors are configured to perform such processes by having access to instructions (e.g., software or computer-readable code) that, when executed by the one or more processors, cause the one or more processors to perform the processes. The instructions are stored in a memory of the computer system. A processor is a central processing unit (CPU), a graphics processing unit (GPU), or any suitable types of processing unit.

A computer system, such as a system or device implementing a process or operation in the examples above, includes one or more computing devices, such as one or more of the systems or devices in FIG. 1. One or more processors of a computer system are included in a single computing device or distributed among a plurality of computing devices. A memory of the computer system includes the respective memory of each computing device of the plurality of computing devices.

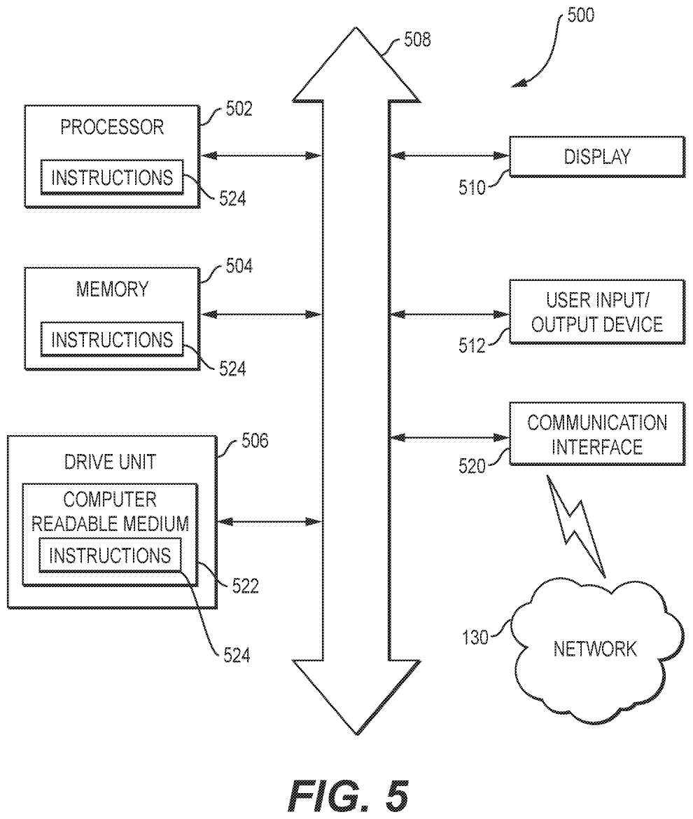

FIG. 5 is a simplified functional block diagram of a computer 500 that is configured as a device for executing the methods of FIGS. 3A-4, according to exemplary embodiments of the present disclosure. For example, the computer 500 is configured as the multi-decision prediction system 135 and/or another system according to exemplary embodiments of this disclosure. In various embodiments, any of the systems herein is a computer 500 including, for example, a data communication interface 520 for packet data communication. The computer 500 also includes a central processing unit (“CPU”) 502, in the form of one or more processors, for executing program instructions. The computer 500 includes an internal communication bus 508, and a storage unit 506 (such as ROM, HDD, SDD, etc.) that may store data on a computer readable medium 522, although the computer 500 may receive programming and data via network communications. The computer 500 may also have a memory 504 (such as RAM) storing instructions 524 for executing techniques presented herein, although the instructions 524 are stored temporarily or permanently within other modules of computer 500 (e.g., processor 502 and/or computer readable medium 522). The computer 500 also includes input and output ports 512 and/or a display 510 to connect with input and output devices such as keyboards, mice, touchscreens, monitors, displays, etc. The various system functions are implemented in a distributed fashion on a number of similar platforms, to distribute the processing load. Alternatively, the systems is implemented by appropriate programming of one computer hardware platform.

Program aspects of the technology are thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that stores the software elements includes optical, electrical and electromagnetic waves, such as used across physical interfaces between local devices, through wired and optical landline networks and over various air-links. The physical elements that carry such waves, such as wired or wireless links, optical links, or the like, also is considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments are applicable to any environment, such as a desktop or laptop computer, an automobile entertainment system, a home entertainment system, etc. Also, the disclosed embodiments are applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

The present disclosure furthermore relates to the following aspects.

Example 1. A system for predicting multiple-sequential-event based outcomes, comprising: one or more storage devices storing computer-readable instructions; one or more processors configured to execute the computer-readable instructions to implement: a first deep neural network that is configured to predict a first decision for a multiple-sequential-event based outcome, and that includes: a first input layer configured to receive as input less than an entirety of a plurality of variables for the multiple-sequential-event based outcome; and an internal layer configured to receive as input a remainder of the plurality of variables appended to an output of a preceding layer, such that the first deep neural network is configured to generate as output a prediction value for the first decision; and a second deep neural network that is configured to predict a second decision subsequent to the first decision for the multiple-sequential-event based outcome, and that includes: a second input layer configured to receive as input a representation of output from the penultimate layer of the first deep neural network appended to at least a portion of a representation of the plurality of variables input into the first deep neural network, wherein the second deep neural network is configured to generate as output a prediction value for the second decision.

Example 2. The system of Example 1, wherein: the first and second deep neural networks are convolutional neural networks; and each of the input to the first layer and the input to the second layer is represented as an input image.

Example 3. The system of Example 2, wherein the representation of the output from the penultimate layer of the first deep neural network that is appended to the input of the second input layer acts as a selection variable and is in the form of a tensor appended to each layer of the input image for the second input layer.

Example 4. The system of any of the preceding examples, wherein: the remainder of the plurality of variables includes one or more variables that are substantially probative of the first decision and that are not substantially probative of the second decision; and the remainder of the plurality of variables act as exclusion restrictions so as to inhibit multi-collinearity in the first and second deep neural networks.

Example 5. The system of any of the preceding examples, wherein the multiple-sequential-event based outcome models a situation in which occurrence of the second decision depends upon a result of the first decision.

Example 6. The system of any of the preceding examples, wherein the first decision relates to whether a medical claim appeal will be filed, and the second decision relates to whether an outcome of the medical claim appeal will be a denial reversal.

Example 7. The system of any of the preceding examples, wherein the first and second neural networks have been trained based on a common dataset of multiple sets of variables.

Example 8. A computer-implemented method of predicting a multiple-sequential-event based outcome using deep learning, comprising: obtaining, by one or more processors, a plurality of variables for the multiple-sequential-event based outcome; identifying, by the one or more processors, less than an entirety of the plurality of variables as first input; injecting, by the one or more processors, a remainder of the plurality of variables as a portion of second input to an internal layer of a first neural network; generating, by the one or more processors, a prediction of a first decision of the multiple-sequential-event based outcome by applying the first input to an input layer of the first neural network, such that a remainder of the variables, e.g., the second input is fed to the internal layer, the penultimate layer of the first neural network configured to generate as output a prediction value for the first decision; generating, by the one or more processors, third input by combining the first input with a representation of output from the penultimate layer; and generating, by the one or more processors, a prediction of a second decision of the multiple-sequential-event based outcome by applying the third input to a further input layer of a second neural network configured to generate as output a prediction value for the second decision.

Example 9. The computer-implemented method of Example 8, wherein: the first and second neural networks are convolutional neural networks; applying the first input to the input layer of the first neural network includes representing the first input as a first input image and providing the first input image to the first input layer; and applying the third input to the further input layer of the second neural network includes representing the third input as a second input image and providing the second input image to the further input layer.

Example 10. The computer-implemented method of Example 9, wherein representing the third input as the second input image includes: generating a partial input image based on the plurality of variables; generating a tensor based on the representation of the output from the penultimate layer; and appending the tensor to each layer of the partial input image.

Example 11. The computer-implemented method of any of Examples 8-10, wherein the remainder of the plurality of variables includes one or more variables that are substantially probative of the first decision and that are not substantially probative of the second decision.

Example 12. The computer-implemented method of any of Examples 8-11, wherein the multiple-sequential-event based outcome models a situation in which occurrence of the second decision depends upon a result of the first decision.

Example 13. The computer-implemented method of any of Examples 8-12, wherein the first decision relates to whether a medical claim appeal will be filed, and the second decision relates to whether an outcome of the medical claim appeal will be a denial reversal.

Example 14. The computer-implemented method of any of Examples 8-13, wherein the first and second neural networks have been trained based on a common dataset of multiple sets of variables.

Example 15. A computer-implemented method of training a series of deep neural networks for predicting multiple-sequential-event based outcomes, comprising: obtaining, by one or more processors, a plurality of training sets, each training set including a respective plurality of variables and respective data describing decision outcomes for at least one decision, a first subset of the plurality of training sets of variables including respective data describing only a first decision outcome, and a second subset of the plurality of training sets of variables including respective data describing the first decision outcome and a second decision outcome; training, by the one or more processors and using the plurality of training sets, a first neural network to generate predictions of the first decision; and training, by the one or more processors and using the second subset of the plurality of training sets, a second neural network to generate predictions of the second decision.

Example 16. The computer-implemented method of Example 15, wherein training the first neural network using the plurality of training sets includes, for each training set: identifying less than an entirety of the respective plurality of variables as first input; applying the first input to a first input layer of the first neural network; providing a remainder of the respective plurality of variables into an internal layer of the first neural network; and adjusting the first neural network based on a comparison of an output of the first neural network with the respective data describing decision outcomes of the first decision.

Example 17. The computer-implemented method of Example 16, wherein training the second neural network to generate predictions of the second decision includes, for each training set in the second subset of the plurality of training sets: generating second input by appending output from the penultimate layer of the first neural network to the second subset of the plurality of training sets of variables; applying the second input to the second neural network; and adjusting the second neural network based on a comparison of an output of the second neural network with the respective data describing decision outcomes of the second decision.

Example 18. The computer-implemented method of Example 17, wherein the remainder of the plurality of variables includes one or more variables that are substantially probative of the first decision and that are not substantially probative of the second decision.

Example 19. The computer-implemented method of any of Examples 15-18, wherein the first and second deep neural networks are convolutional neural networks.

Example 20. The computer-implemented method of any of Examples 15-19, wherein the first decision relates to whether a medical claim appeal will be filed, and the second decision relates to whether an outcome of the medical claim appeal will be a denial reversal.

What is claimed is:

1. A system for predicting multiple-sequential-event based outcomes, comprising:
one or more storage devices storing computer-readable instructions;
one or more processors configured to execute the computer-readable instructions to implement:
a first deep neural network that is configured to predict a first decision for a multiple-sequential-event based outcome, and that includes:
a first input layer configured to receive as input less than an entirety of a plurality of variables for the multiple-sequential-event based outcome; and
an internal layer configured to receive as input a remainder of the plurality of variables appended to an output of a preceding layer, such that a penultimate layer of the first deep neural network is configured to generate as output a prediction value for the first decision; and
a second deep neural network that is configured to predict a second decision subsequent to the first decision for the multiple-sequential-event based outcome, and that includes:
a second input layer configured to receive as input a representation of output from the penultimate layer of the first deep neural network appended to at least a portion of the plurality of variables,
wherein the second deep neural network is configured to generate as output a prediction value for the second decision.

2. The system of claim 1, wherein:
the first and second deep neural networks are convolutional neural networks; and
each of the input to the first layer and the input to the second layer is represented as an input image.

3. The system of claim 2, wherein the representation of the output from penultimate layer of the first deep neural network that is appended to the input of the second input layer acts as a selection variable and is in the form of a tensor appended to each layer of the input image for the second input layer.

4. The system of claim 1, wherein:
the remainder of the plurality of variables includes one or more variables that are substantially probative of the first decision and that are not substantially probative of the second decision; and
the remainder of the plurality of variables act as exclusion restrictions so as to inhibit multi-collinearity in the first and second deep neural networks.

5. The system of claim 1, wherein the multiple-sequential-event based outcome models a situation in which occurrence of the second decision depends upon a result of the first decision.

6. The system of claim 1, wherein the first decision relates to whether a medical claim appeal will be filed, and the second decision relates to whether an outcome of the medical claim appeal will be a denial reversal.

7. The system of claim 1, wherein the first and second neural networks have been trained based on a common dataset of multiple sets of variables.

8. A computer-implemented method of predicting a multiple-sequential-event based outcome using deep learning, comprising:
obtaining, by one or more processors, a plurality of variables for the multiple-sequential-event based outcome;
identifying, by the one or more processors, less than an entirety of the plurality of variables as first input;
injecting, by the one or more processors, a remainder of the plurality of variables as a portion of second input to an internal layer of a first neural network;
generating, by the one or more processors, a prediction of a first decision of the multiple-sequential-event based outcome by applying the first input to an input layer of the first neural network, such that a remainder of the second input is fed to the internal layer, a penultimate layer of the first neural network configured to generate as output a prediction value for the first decision;
generating, by the one or more processors, third input by combining the first input with a representation of output from the penultimate layer; and
generating, by the one or more processors, a prediction of a second decision of the multiple-sequential-event based outcome by applying the third input to a further input layer of a second neural network configured to generate as output a prediction value for the second decision.

9. The computer-implemented method of claim 8, wherein:
the first and second neural networks are convolutional neural networks;
applying the first input to the input layer of the first neural network includes representing the first input as a first input image and providing the first input image to the first input layer; and
applying the third input to the further input layer of the second neural network includes representing the third input as a second input image and providing the second input image to the further input layer.

10. The computer-implemented method of claim 9, wherein representing the third input as the second input image includes:
generating a partial input image based on the plurality of variables;
generating a tensor based on the representation of the output from the penultimate layer; and
appending the tensor to each layer of the partial input image.

11. The computer-implemented method of claim 8, wherein the remainder of the plurality of variables includes one or more variables that are substantially probative of the first decision and that are not substantially probative of the second decision.

12. The computer-implemented method of claim 8, wherein the multiple-sequential-event based outcome models a situation in which occurrence of the second decision depends upon a result of the first decision.

13. The computer-implemented method of claim 8, wherein the first decision relates to whether a medical claim appeal will be filed, and the second decision relates to whether an outcome of the medical claim appeal will be a denial reversal.

14. The computer-implemented method of claim 8, wherein the first and second neural networks have been trained based on a common dataset of multiple sets of variables.

15. A computer-implemented method of training a series of deep neural networks for predicting multiple-sequential-event based outcomes, comprising:
obtaining, by one or more processors, a plurality of training sets of variables, each training set including a respective plurality of variables and respective data describing decision outcomes for at least one decision, a first subset of the plurality of training sets of variables including respective data describing only a first decision outcome, and a second subset of the plurality of training sets of variables including respective data describing the first decision outcome and a second decision outcome;
training, by the one or more processors and using the plurality of training sets, a first neural network to generate predictions of the first decision; and
training, by the one or more processors and using the second subset of the plurality of training sets, a second neural network to generate predictions of the second decision.

16. The computer-implemented method of claim 15, wherein training the first neural network using the plurality of training sets includes, for each training set:
identifying less than an entirety of the respective plurality of variables as first input;
applying the first input to a first input layer of the first neural network;
providing a remainder of the respective plurality of variables into a penultimate layer of the first neural network; and
adjusting the first neural network based on a comparison of an output of the first neural network with the respective data describing decision outcomes of the first decision.

17. The computer-implemented method of claim 16, wherein training the second neural network to generate predictions of the second decision includes, for each training set in the second subset of the plurality of training sets:
generating second input by appending output from the penultimate layer of the first neural network to the second subset of the plurality of training sets;
applying the second input to the second neural network; and
adjusting the second neural network based on a comparison of an output of the second neural network with the respective data describing decision outcomes of the second decision.

18. The computer-implemented method of claim 17, wherein the remainder of the plurality of variables includes one or more variables that are substantially probative of the first decision and that are not substantially probative of the second decision.

19. The computer-implemented method of claim 15, wherein the first and second deep neural networks are convolutional neural networks.

20. The computer-implemented method of claim 15, wherein the first decision relates to whether a medical claim appeal will be filed, and the second decision relates to whether an outcome of the medical claim appeal will be a denial reversal.
